(19) United States
(12) Patent Application Publication
(10) Pub. No.: US 2014/0363713 A1
(43) Pub. Date: Dec. 11, 2014

(54) ELECTRICAL ENERGY STORAGE CELL AND METHOD FOR PRODUCING AN ELECTRICAL ENERGY STORAGE CELL

(71) Applicant: Robert Bosch GmbH, Stuttgart (DE)

(72) Inventors: Alexander Schmidt, Donaueschingen (DE); Andy Tiefenbach, Vaihingen-Horrheim (DE); Volker Doege, Dischingen (DE); Martin Kessler, Schwaebisch Gmuend (DE)

(21) Appl. No.: 14/366,960

(22) PCT Filed: Nov. 14, 2012
(86) PCT No.: PCT/EP2012/072574

§ 371 Date: Jun. 19, 2014

(30) Foreign Application Priority Data
Dec. 19, 2011 (DE) 10 2011 089 088.2

(51) Int. Cl. H01M 2/26; H01M 2/06; H01M 10/04

(52) U.S. Cl. CPC H01M 2/26; H01M 10/0431; H01M 2/06
USPC 429/94; 429/209; 429/246; 429/179; 29/623.1

(57) ABSTRACT

The invention relates to an electrical energy storage cell comprising a multiplicity of first electrode elements with parallel surfaces, a multiplicity of second electrode elements with parallel surfaces which run parallel to the surfaces of the first electrode elements, which second electrode elements are galvanically isolated from the first electrode elements, a first planar contact element, which makes electrical contact with the multiplicity of first electrode elements, a second planar contact element, which makes electrical contact with the multiplicity of second electrode elements, at least one first planar contact connector, which makes electrical contact with the first contact element, a first pole contact, which makes electrical contact with the first planar contact connector, and a second pole contact, which is electrically connected to the second planar contact element.

### BACKGROUND OF THE INVENTION

The invention relates to an electrical energy storage cell and to a method for producing an electrical energy storage cell.

Customarily, direct current is removed from electrical energy storage cells or direct current is fed into the latter. The previously known structure of energy storage cells is therefore designed to optimize the ohmic internal resistances and the specific energy density or power density of the energy storage cells.

The document US 2007/0148542 A1 discloses, for example, a battery electrode design with an electrode stack which is connected by the electrode surfaces via continuous pole contacts.

The document US 2009/0029240 A1 discloses a cylindrical battery cell with electrode windings which are connected to one another in each case at two ends of the battery via contact tabs.

In many applications of electrical energy storage cells, storage cells are connected to one another in a serial or parallel arrangement to form battery modules in order to set desired starting parameters, such as overall voltage, voltage range, energy content or power density. If currents having an increasing alternating portion are removed from energy storage cells of this type, the influence of the distributed inductance of the energy storage cells increases depending on the frequency. The inductive losses of an energy storage cell are composed of the individual portions of the contributions to the loss made by the electrodes, the pole connection and the arrangement of the electrodes in the housing.

Energy storage cells which have lower losses in respect of removing alternating currents of high frequency and thus improve the efficiency of the system using the energy storage cells are therefore required.

### SUMMARY OF THE INVENTION

According to one aspect, the present invention provides an electrical energy storage cell, comprising a multiplicity of first two-dimensionally parallel electrode elements, a multiplicity of second two-dimensionally parallel electrode elements which run in a two-dimensionally parallel manner to the first electrode elements and are galvanically separated from the first electrode elements, a first two-dimensional contact element which makes electrical contact with the multiplicity of first electrode elements, a second two-dimensional contact element which makes electrical contact with the multiplicity of second electrode elements, at least one first two-dimensional contact connector which makes electrical contact with the first contact element, a first pole contact which makes electrical contact with the first two-dimensional contact connector, and a second pole contact which is electrically connected to the second two-dimensional contact element.

According to a further aspect, the present invention provides a method for producing an electrical energy storage cell, with the steps of making electrical contact with a multiplicity of first two-dimensionally parallel electrode elements by a first two-dimensional contact element, of making electrical contact with a multiplicity of second two-dimensionally parallel electrode elements which run in a two-dimensionally parallel manner to the first electrode elements and are galvanically separated from the first electrode elements, by a second two-dimensional contact element, of making electrical contact with the first contact element by at least one first two-dimensional contact connector, of making electrical contact with the first two-dimensional contact connector by a first pole contact, and electrically connecting the second two-dimensional contact element to a second pole contact.

One concept of the present invention is to reduce the inductive losses during the activation of an electrical energy storage cell by means of a suitable structure of the energy storage cell with as little internal cell inductance as possible. For this purpose, the internal current-conducting conductor elements of the energy storage cell are suitably arranged in such a manner that, firstly, the current-conducting conductor elements enclose as little area as possible, and, secondly, the effective flow paths have as little length as possible with a maximally homogeneously distributed current density such that the inductive internal impedance of the energy storage cell is minimized.

A considerable advantage consists in that the lost energy, in particular during the removal of alternating current of high frequency from the energy storage cell, can be considerably reduced. This reduction in the lost energy is of great advantage in particular in the case of battery systems with an integrated inverter, what are referred to as battery direct inverters, BDI, in which the current conduction through a battery module is rapidly changed in order to vary the current voltage.

A further advantage consists in that the short-term dynamics of such energy storage cells are improved by the delay in the output of energy or load from the energy storage cells after load changes is minimized. It is thereby advantageously possible to dispense with otherwise possibly compensating structural elements, such as, for example, buffer capacities, which can reduce the construction space required and also the manufacturing costs of components using energy storage cells.

Furthermore, the electromagnetic compatibility (EMC) can be improved by avoiding inductive lost portions by the energy storage cells, since the electromagnetic fields emitted can be decreased and interfering influences on adjacent electronic components reduced.

According to an embodiment of the energy storage cell according to the invention, the first pole contact and the second pole contact can be guided parallel to each other.

According to a further embodiment of the energy storage cell according to the invention, the first two-dimensional contact connector can run in a two-dimensionally parallel manner to the first and second electrode elements.

According to a further embodiment, the energy storage cell according to the invention can furthermore have at least one second two-dimensional contact connector which makes electrical contact with the second contact element and which runs in a two-dimensionally parallel manner to the first and second electrode elements. The second pole contact can make electrical contact here with the second two-dimensional contact connector. With the aid of the second two-dimensional contact connector, a large area can advantageously be created, via which current in the energy storage cell flows parallel along the first and the second two-dimensional contact connector. This considerably reduces the electrical internal resistance of the energy storage cell. Furthermore, actions of undesirable effects, such as, for example, the skin effect, can thereby be reduced.

According to a further embodiment of the energy storage cell according to the invention, the second two-dimensional contact connector can run in a two-dimensionally parallel manner to the first two-dimensional contact connector at a predetermined connector distance. For example, in one embodiment, the predetermined connector distance can be smaller than a distance between adjacent electrode elements. By reducing the connector distance, the through-flow surface, which is relevant to the inductive internal impedance of the energy storage cell, between components conducting the electrical current can advantageously be reduced.

According to a further embodiment, the energy storage cell according to the invention can furthermore have a first insulating layer which is arranged between the first two-dimensional contact connector and the second two-dimensional contact connector and which galvanically separates the first two-dimensional contact connector and the second two-dimensional contact connector from each other. As a result, by maintaining a predefined distance, a potential separation between the contact connectors in the interior of the energy storage cell can be ensured in a simple manner.

According to a further embodiment of the energy storage cell according to the invention, the first pole contact and the second pole contact can be of two-dimensional design. This affords the advantage of the energy storage cell having a low input or output impedance.

According to a further embodiment, the energy storage cell according to the invention can furthermore have a second insulating layer which is arranged between the first pole contact and the second pole contact and which galvanically separates the first pole contact and the second pole contact from each other. Said second insulating layer can be formed integrally with the first insulating layer and by maintaining a predefined pole contact distance, ensures a potential separation between the pole contacts in a simple manner.

According to a further embodiment of the energy storage cell according to the invention, the first and second electrode elements can be designed as electrode stacks. According to an alternative embodiment of the energy storage cell according to the invention, the first and second electrode elements can be wound spirally one inside the other.

As a result, an energy storage cell of low inductive internal impedance can be implemented for various customary storage cell geometries, such as cylindrical winding cells or pouch cells.

According to a further embodiment, the energy storage cell according to the invention can furthermore have a housing which encloses the first and second electrode elements, the first and second contact elements and the first contact connector. The first and second pole contacts here as electrical terminals of the energy storage cell can be guided out of the housing.

According to a further embodiment of the energy storage cell according to the invention, at least one of the components of the first contact element, of the second contact element and of the first contact connector can be designed as part of the housing. As a result, the energy storage cell can advantageously be designed in a compact and mechanically stable manner and so as to be separated galvanically from the outside world.

Further features and advantages of embodiments of the invention emerge from the description below with respect to the attached drawings.

### BRIEF DESCRIPTION OF THE DRAWINGS

In the drawings:

FIG. 1 shows a schematic illustration of an electrical energy storage cell according to one embodiment of the invention;

FIG. 2 shows a schematic illustration of an electrical energy storage cell according to a further embodiment of the invention;

FIG. 3 shows a schematic illustration of an electrical energy storage cell according to a further embodiment of the invention;

FIG. 4 shows a schematic illustration of an electrical energy storage cell according to a further embodiment of the invention; and

FIG. 5 shows a schematic illustration of a method for producing an electrical energy storage cell according to a further embodiment of the invention.

### DETAILED DESCRIPTION

Electrical energy storage cells within the context of the present invention comprise all devices which can store electrical energy over a predefined time period and can output said electrical energy again over a further time period. Energy storage cells within the context of the present invention here comprise all types of secondary and primary energy stores, in particular electrically capacitive, electrochemical (Faraday's) and store types which operate in a combined manner. The time periods considered can here comprise from seconds up to hours, days or years. Electrical energy storage cells can comprise, for example, lithium-ion cells, lithium polymer cells, nickel/metal hydride cells, ultra-capacitors, super-capacitors, power-capacitors, batcaps, accumulators based on lead, zinc, sodium, lithium, magnesium, sulfur or other metals, elements or alloys, or similar systems. The functionality of the electrical energy storage cells encompassed by the invention can be based here on intercalation electrodes, reaction electrodes or alloy electrodes in combination with aqueous, aprotic or polymer electrolytes.

The structure of electrical energy storage cells within the context of the present invention can here comprise different outer structural shapes, such as, for example, cylindrical shapes, prismatic shapes or what are referred to as pouch shapes, and also different electrode structures, such as, for example, wound, stacked, folded structures or other structures.

Electrode elements within the context of the present invention can be reproduced from various electrically conductive materials, for example metallic materials. Electrode elements within the context of the present invention can be produced in a coated form, in a manner filled three-dimensionally and/or with a large active surface. The two-dimensional electrode elements here can have different dimensions depending on the storage technology, for example the thickness of electrode elements can have orders of magnitude of several m up to a few mm. The electrode elements can be folded, stacked or wound, and provision may be made for insulating or separating layers which galvanically separate the electrode elements from one another to be arranged between the electrode elements. It may also be possible to construct the electrode elements in a bipolar form. The two-dimensional shape of the electrode elements may be square, rectangular, round, elliptical or configured in any other desired way.

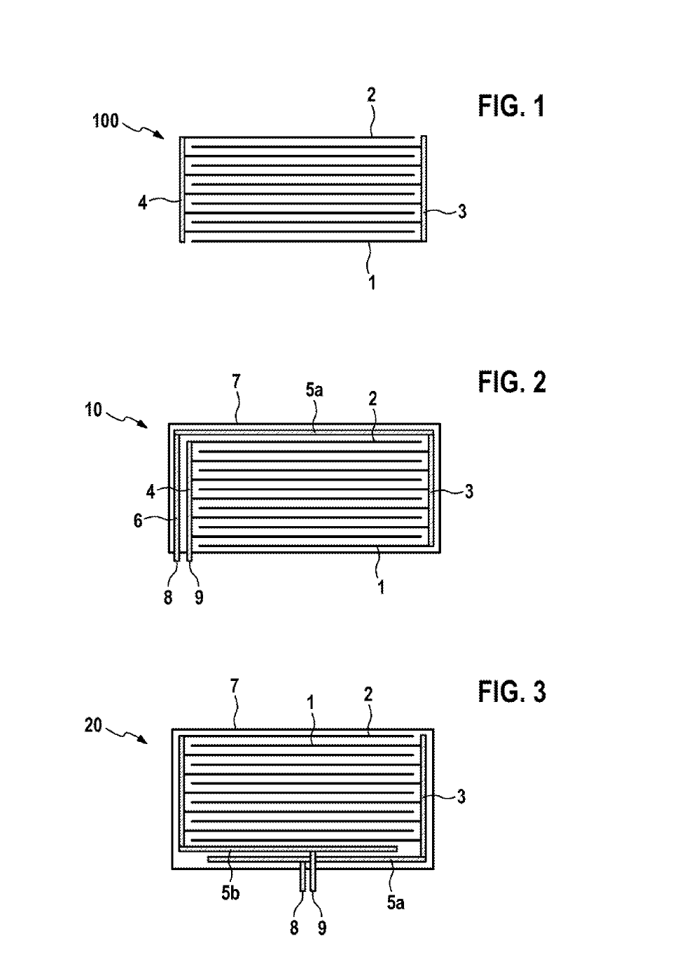

FIG. 1 shows a schematic illustration of an electrical energy storage cell 100. The energy storage cell 100 comprises a multiplicity of first two-dimensionally parallel electrode elements 1 and a multiplicity of two-dimensionally parallel second electrode elements 2 which run in a two-dimensionally parallel manner to the first electrode elements 1 and are galvanically separated from the first electrode elements 1. The electrode elements 1 and 2 can be, for example, flat layers made of electrically conductive material, which are intermeshed one in the other in a two-dimensional manner in a comb-like structure. It may also be possible for the electrode elements 1 and 2 to have been brought into the alternative stack shape illustrated in FIG. 1 by winding or folding a strip of layered electrode elements. For example, the first and second elements 1 and 2 can be designed as electrode stacks. As an alternative thereto, the first and second electrode elements 1 and 2 can be wound one in the other in a spiral manner. It should be clear here that there is a wide variety of possible ways in which the electrode elements 1 and 2 can be arranged with respect to one another and that the selection of an arrangement may be dependent on the storage technology used, the peripheral conditions with respect to the outer shape of the energy storage cell 100 and/or the electrical characteristics to be obtained for the energy storage cell 100. For example, it may be advantageous to arrange the electrode elements 1 and 2 in such a manner that the internal volume of the energy storage cell 100 is used to a maximum extent.

The energy storage cell 100 furthermore has a first two-dimensional contact element 3 which makes electrical contact with the multiplicity of first electrode elements 1. Equally, a second two-dimensional contact element 4 which makes electrical contact with the multiplicity of second electrode elements 2 is provided. The contact elements 3 and 4 can be, for example, flat strips or layers of electrically conductive material with which the electrode elements 1 and 2 make contact on opposite sides of the two-dimensionally parallel layers. This type of contact connection results in minimum lengths for the effective current path and/or in a maximally uniformly distributed current density over the layering of electrode elements 1 and 2. The two-dimensional contact connection of the contact elements 3 and 4 with the electrode elements 1 and 2 can be achieved, for example, by means of welding, spraying, sputtering or adhesive bonding methods. Alternatively, use may also be made of special three-dimensionally filled structures with solid outer surfaces in order to form the geometry of the electrode elements 1 and 2 and of the contact elements 3 and 4. Provision can be made here to keep the excess length of the contact elements 3 and 4 beyond the vertical extent of the respective layers of electrode elements 1 and 2 as small as possible in order to avoid superfluous current paths.

FIG. 2 shows a schematic illustration of an electrical energy storage cell 10. The energy storage cell 10 differs from the energy storage cell 100 in FIG. 1 to the effect that a first two-dimensional contact connector 5a which makes electrical contact with the first contact element 3 and which runs in a two-dimensionally parallel manner to the first and second electrode elements 1 and 2 is provided. The first two-dimensional contact connector 5a can be, for example, a layer made from conductive material which, although it does not have any direct galvanic contact with the electrode elements 1, is in contact galvanically with the electrode elements 1 indirectly via the first contact element 3. The first contact element 3 and the first two-dimensional contact connector 5a here can also be constructed from separate components, for example adapted line sections which have two or more structural components connected electrically to one another. The energy storage cell 10 furthermore has a first pole contact 8 which makes electrical contact with the first two-dimensional contact connector 5a. Equally, a second pole contact 9 which is electrically connected to the second two-dimensional contact element 4 is provided. The first pole contact 8 and the second pole contact 9 are guided parallel to each other. The first pole contact 8 and the second pole contact 9 can have, for example, two-dimensional layers or planar layer elements which are guided parallel to one another in a layer region 6. For example, an insulating layer (not illustrated) which galvanically separates the first pole contact 8 and the second pole contact 9 from each other can be arranged between the first pole contact 8 and the second pole contact 9. This may be, for example, a gas section; however, provision may also be made to use a solid body insulating layer.

The elements illustrated can run in a two-dimensionally parallel manner to one another into the depths in the plane of the drawing of the energy storage cell 10 illustrated in FIG. 2. This can take place, for example, over the entire width of the energy storage cell 10, wherein it may also be possible in principle only to guide partial regions of the pole contacts 8 and 9 in a two-dimensional manner one above the other into the depths. The pole contacts 8 and 9 here can be guided outward in a predefined section of the energy storage cell 10. The energy storage cell 10 can have a housing 7 which encloses the first and second electrode elements 1 and 2, the first and second contact elements 3 and 4 and the first contact connector 5a. The first and second pole contacts 8 and 9 here as electrical terminals of the energy storage cell 10 are guided out of the housing 7. For example, the first and second pole contacts 8 and 9, or alternatively at least one of the two first and second pole contacts 8 and 9, can be electrically insulated from the housing 7. It is also possible for one of the two first and second pole contacts 8 and 9 to make electrical contact with the housing 7 if the housing 7 is composed of an electrically conductive material or at least have electrically conductive partial regions. If the housing 7 is composed of an electrically insulating material, for example plastic, the two first and second pole contacts 8 and 9 can be guided directly, that is to say without further insulation, through the housing wall of the housing 7.

It may be possible here, for example, to design at least one of the components located in the interior of the energy storage cell 10 as part of the housing 7. For example, the housing 7 can be of electrically conductive design in a partial region in a region above the electrode elements 1 and 2 such that, for example, instead of a separate first contact connector 5a, the first contact connector 5a is part of the housing 7. In a similar manner, partial regions of the housing 7 can also be used for forming one or more of the pole contacts 8 and 9, for example in the layer region 6 which is adjacent to one side of the housing 7. Care should be taken in each case here to ensure that the housing 7 itself has sufficient galvanic insulation between corresponding electrically conductive partial regions in order to ensure the functionality of the energy storage cell 10 as a whole.

FIG. 3 shows a schematic illustration of an electrical energy storage cell 20. The energy storage cell 20 differs from the energy storage cell 10 in FIG. 2 to the effect that a second two-dimensional contact connector 5b which makes electrical contact with the second contact element 4 and which runs in a two-dimensionally parallel manner to the first and second electrode elements 1 and 2 is provided. The second pole contact 9 here makes electrical contact with the second two-dimensional contact connector 5b. The second two-dimensional contact connector 5b can run in a two-dimensionally parallel manner to the first two-dimensional contact connector 5a at a predetermined connector distance. For example, the predetermined connector distance can be smaller than a distance between adjacent electrode elements 1 and 2. Correspondingly, an insulating layer (not illustrated) which galvanically separates the contact connectors 5a and 5b from each other can be arranged between the first two-dimensional contact connector 5a and the second two-dimensional contact connector 5b.

The pole contacts 8 and 9 lead parallel to each other out of the housing 7 of the energy storage cell 20. In order to be able to ensure corresponding galvanic insulation, for example, between the pole contact 9 and the first two-dimensional contact connector 5a, it may be necessary to pierce the second two-dimensional contact connector 5b in an electrically insulated manner. The pole contacts 8 and 9 can be, for example, likewise two-dimensional layer elements, strips or else wires with a predefined pole contact distance from one another. In this case, the pole contacts 8 and 9 can be considered to be leadthroughs of the poles through the housing 7, said leadthroughs being guided out over the entire length or over partial regions of the corresponding housing side.

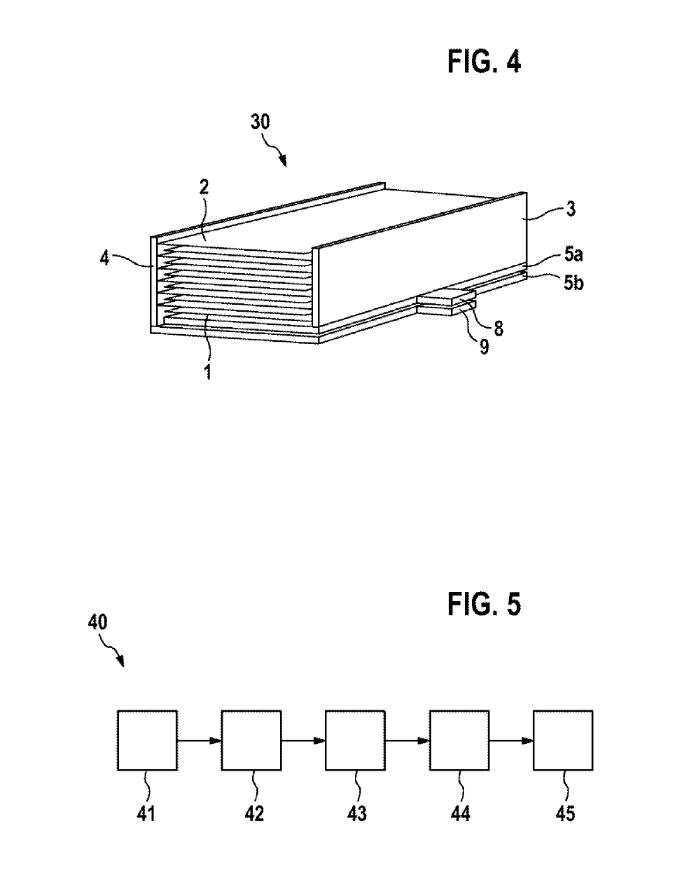

FIG. 4 shows a schematic illustration of an electrical energy storage cell 30 in a perspective view. The energy storage cell 30 differs from the energy storage cell 20 in FIG. 3 substantially to the effect that the pole contacts 8 and 9 are guided out of the housing (not shown for reasons of clarity) of the energy storage cell 30 in one plane with the two-dimensional contact connectors 5a and 5b. The pole contacts 8 and 9 here are arranged, by way of example, centrally along the depth extent of the energy storage cell 30; however, it may also be possible to shift the pole contacts 8 and 9 in a direction of one of the two wide sides of the energy storage cell 30, or to make leadthroughs of the pole contacts 8 and 9 at a plurality of locations or along the whole of the wide sides.

Overall, FIGS. 1 to 4 merely show exemplary embodiments of energy storage cells. Variations and modifications can be configured taking into account expedient construction criteria. In general, it is advantageous to keep the distances between current-conducting elements of the two polarities as short as possible in order to minimize the active through-flow surface enclosed by said elements. This means that the inductive impedance of the current-conducting elements in the interior of the energy storage cell can be minimized. In addition, it is advantageous to design the current-conducting elements to be as large as possible in area in order to distribute the current density as homogeneously as possible. If an ideally two-dimensional pole contact connection bearing closely against the active areas of the electrode elements is possible only under certain peripheral conditions, such as, for example, safety requirements or technical constraints, it is necessary to ensure at least that the current-conducting elements of different polarity are brought together at a short distance from one another.

The illustrated energy storage cells can preferably be used, for example, in systems in which alternating currents of high frequency are removed from the energy storage cells, for example in battery direct inverters with activation frequencies above approximately 100 Hz. In these systems, inductive losses due to the high alternating current frequency can be minimized owing to the design of the energy storage cells. At the same time, the response behavior of the energy storage cells in the short-term range is improved, which considerably improves the dynamics and reliability of the systems.

In general, the energy storage cells are also advantageous for use in systems having smaller activation frequencies, for example in systems with discrete switching operations within the range of seconds, which can have correspondingly high frequency portions during the switching.

FIG. 5 shows a schematic illustration of a method 40 for producing an electrical energy storage cell, in particular one of the energy storage cells 10, 20 or 30 shown schematically in FIGS. 2 to 4. In a first step 41, electrical contact with a multiplicity of first two-dimensionally parallel electrode elements 1 is made by a first two-dimensional contact element 3. In a second step 42, electrical contact with a multiplicity of second two-dimensionally parallel electrode elements 2 which run in a two-dimensionally parallel manner to the first electrode elements 1 and are galvanically separated from the first electrode elements 1 is made by a second two-dimensional contact element 4. The first and second contact elements 3 and 4 can be placed in contact here with the electrode elements by, for example, a welding method, a spraying method, a sputtering method or an adhesive bonding method. The electrical resistance of the connecting point between the respective contact element 3, 4 and the electrode elements 1, 2 should preferably be kept as small as possible here.

The first and second two-dimensionally parallel electrode elements 1 and 2 can be suitably stacked, folded or wound, depending on the desired cell topology, for example before contact is made with the respective contact elements 3 or 4. For example, for a cylindrical cell, the first and second two-dimensionally parallel electrode elements 1 and 2 separated by an insulating separator layer can be wound in what is referred to as jelly roll topology, that is to say, in a cylindrical winding having an alternating sequence of different electrode or separator layers in cross section. Alternatively, for what is referred to as a pouch cell, the first and second two-dimensionally parallel electrode elements 1 and 2 can be folded or layered on one another using an insulating separator layer in meandering tracks. In order to form a prismatic cell, it is possible, for example, to use a “racetrack pancake” topology or a “racetrack double pancake” topology, that is to say, a flat spiral-shaped winding of first and second two-dimensionally parallel electrode elements 1 and 2 which can be compressed along a cross-sectional direction of the arising winding in order to obtain a “racetrack” shape, that is to say, a winding path which is connected by means of tight external radii and runs substantially parallel.

In a third step 43, electrical contact is made with the first contact element 3 by at least one first two-dimensional contact connector 5a which can run in a two-dimensionally parallel manner to the first and second electrode elements 1 and 2. In a fourth step 44, electrical contact is made with the first two-dimensional contact connector 5a by a first pole contact 8. Finally, in a fifth step 45, the second two-dimensional contact element 4 is electrically connected to a second pole contact 9. The first pole contact 8 and the second pole contact 9 can be guided parallel to each other here.

The first and second electrode elements 1, 2, the first and second contact elements 3, 4 and the first contact connector 5a can optionally be enclosed in a housing 7. The first and second pole contacts 8, 9 can be guided here out of the housing 7 as electrical terminals of the energy storage cell.

1. An electrical energy storage cell (10; 20; 30), comprising:
a multiplicity of first two-dimensionally parallel electrode elements (1);
a multiplicity of second two-dimensionally parallel electrode elements (2) which run in a two-dimensionally parallel manner to the first electrode elements (1) and are galvanically separated from the first electrode elements (1);
a first two-dimensional contact element (3) which makes electrical contact with the multiplicity of first electrode elements (1);
a second two-dimensional contact element (4) which makes electrical contact with the multiplicity of second electrode elements (2);
at least one first two-dimensional contact connector (5a) which makes electrical contact with the first contact element (3);
a first pole contact (8) which makes electrical contact with the first two-dimensional contact connector (5a); and
a second pole contact (9) which is electrically connected to the second two-dimensional contact element (4).

2. The electrical energy storage cell (10; 20; 30) as claimed in claim 1, wherein the at least one first two-dimensional contact connector (5a) runs in a two-dimensionally parallel manner to the first and second electrode elements (1; 2).

3. The electrical energy storage cell (10; 20; 30) as claimed in claim 1, wherein the first pole contact (8) and the second pole contact (9) are guided parallel to each other.

4. The electrical energy storage cell (10; 20; 30) as claimed in claim 1, furthermore comprising:
at least one second two-dimensional contact connector (5b) which makes electrical contact with the second contact element (4) and which runs in a two-dimensionally parallel manner to the first and second electrode elements (1; 2), wherein the second pole contact (9) makes electrical contact with the second two-dimensional contact connector (5b).

5. The electrical energy storage cell (10; 20; 30) as claimed in claim 4, wherein the second two-dimensional contact connector (5b) runs in a two-dimensionally parallel manner to the first two-dimensional contact connector (5a) at a predetermined connector distance.

6. The electrical energy storage cell (10; 20; 30) as claimed in claim 5, wherein the predetermined connector distance is smaller than a distance between adjacent electrode elements (1; 2).

7. The electrical energy storage cell (10; 20; 30) as claimed in claim 4, furthermore comprising:
a first insulating layer which is arranged between the first two-dimensional contact connector (5a) and the second two-dimensional contact connector (5b) and which galvanically separates the first two-dimensional contact connector (5a) and the second two-dimensional contact connector (5b) from each other.

8. The electrical energy storage cell (10; 20; 30) as claimed in claim 1, wherein the first pole contact (8) and the second pole contact (9) are of two-dimensional design.

9. The electrical energy storage cell (10; 20; 30) as claimed in claim 8, furthermore comprising:
a second insulating layer which is arranged between the first pole contact (8) and the second pole contact (9) and which galvanically separates the first pole contact (8) and the second pole contact (9) from each other.

10. The electrical energy storage cell (10; 20; 30) as claimed in claim 1, wherein the first and second electrode elements (1; 2) are designed as electrode stacks.

11. The electrical energy storage cell (10; 20; 30) as claimed in claim 1, wherein the first and second electrode elements (1, 2) are wound spirally one inside the other.

12. The electrical energy storage cell (10; 20; 30) as claimed in claim 1, furthermore comprising:
a housing (7) which encloses the first and second electrode elements (1; 2), the first and second contact elements (3; 4) and the first contact connector (5a), wherein the first and second pole contacts (8; 9) are guided out of the housing (7) as electrical terminals of the energy storage cell (10; 20; 30).

13. The electrical energy storage cell (10; 20; 30) as claimed in claim 12, wherein at least one of the components of the first contact element (3), of the second contact element (4) and of the first contact connector (5a) are designed as part of the housing (7).

14. A method (40) for producing an electrical energy storage cell (10; 20; 30) as claimed in claim 1, comprising the following steps:
making electrical contact (41) with a multiplicity of first two-dimensionally parallel electrode elements (1) by a first two-dimensional contact element (3);
making electrical contact (42) with a multiplicity of second two-dimensionally parallel electrode elements (2) which run in a two-dimensionally parallel manner to the first electrode elements (1) and are galvanically separated from the first electrode elements (1), by a second two-dimensional contact element (4);
making electrical contact (43) with the first contact element (3) by at least one first two-dimensional contact connector (5 a);
making electrical contact (44) with the first two-dimensional contact connector (5a) by a first pole contact (8); and
electrically connecting (45) the second two-dimensional contact element (4) to a second pole contact (9).

15. The method (40) as claimed in claim 14, furthermore comprising the following step:
enclosing the first and second electrode elements (1; 2), the first and second contact elements (3; 4) and the first contact connector (5a) in a housing (7), wherein the first and second pole contacts (8; 9) are guided parallel to one another and are guided out of the housing (7) as electrical terminals of the energy storage cell (10; 20; 30).
